(19) United States
(12) Patent Application Publication
(10) Pub. No.: US 2001/0049012 A1
(43) Pub. Date: Dec. 6, 2001

(54) ENAMEL COMPOSITION AND A METHOD OF APPLYING THE ENAMEL COMPOSITION

(76) Inventors: SUSAN M. PAOLINI, NEW YORK, NY (US); LARRY QUEK, NEW YORK, NY (US)

Correspondence Address: THOMAS C. MCDONOUGH, ALTHEIMER & GRAY, 10 SOUTH WACKER DRIVE, SUITE 3800, CHICAGO, IL, 60606, US

(21) Appl. No.: 09/270,296

(22) Filed: Mar. 15, 1999

(51) Int. Cl. B32B 5/16

(52) U.S. Cl. 428/325; 428/323; 428/436

(57) ABSTRACT

The present invention provides a new and useful enamel composition and method capable of and for applying the enamel composition to smooth substrate surfaces, such as, glass or plastic. The enamel composition includes a granular material mixed with a binder having adhesive properties. Moreover, the granular material included in the enamel composition is comprised of minerals and the minerals, besides enabling the enamel composition to adhere to smooth substrate surfaces, also act as a coloring agent for the enamel composition. Further, the enamel composition will adhere to the substrate surface without requiring heating, curing, chemical treatment, roughening or other special preparation of the substrate surface.

### FIELD OF THE INVENTION

The present invention relates generally to a method for applying an enamel composition to a smooth substrate surface.

### BACKGROUND OF THE INVENTION

More particularly, the present invention relates to a method for applying the enamel composition to form colored designs on the inside surface of round or oval ornaments or decorations made of smooth substrates, such as glass or plastic, without heating or roughening the substrate. It has been widely known in the art to provide round and oval, hollow glass ornaments for seasonal holidays. Although many of such ornaments have used mirrored finishes, such as silver and gold, manufacturers also decorate these ornaments by painting designs on the inside of these ornaments. It is well known in the art of decorating the inside surface of glass ornaments to roughen or etch the glass to allow oil-based paints and other paints to adhere to the glass.

In addition, it is known in the art to use heating or curing techniques to apply paint to the smooth surfaces of substrates such as glass. For example, U.S. Pat. No. 4,837,383, issued to Ray Andrews on Jun. 6, 1989 (“Andrews”), discloses a glass enamel composition that may be fired upon a glass substrate to paint opaque ceramic colors. This method includes the steps of applying the glass enamel composition to the glass, drying the glass enamel composition, and firing the substrate. Thus, Andrews does not disclose a method for applying an enamel composition to a smooth substrate without heating or firing the substrate.

U.S. Pat. No. 4,684,389, issued to Premakaran T. Boaz on Aug. 4, 1987 (“Boaz”), discloses a method of forming a glass sheet with an oil-based ceramic paint thereon. The method includes the steps of applying the oil-based ceramic paint to the glass, heating the glass sheet to soften the glass and to allow the remaining portion of the oil-based ceramic paint to bond thereto, engaging the glass sheet with a fiberglass die to form the glass in the desired shape, removing the die and cooling the glass sheet. Therefore, Boaz also requires heating the glass or substrate as a step in applying the paint. Based on the foregoing, it is clear that until now manufacturers of decorative glass ornaments have been unable to provide colored designs on the inside surfaces of such ornaments without heating, curing, chemically treating or roughening the glass.

It is therefore an object of the present invention to provide an enamel composition and a method for applying the enamel composition which overcomes the problems associated with the prior art.

### SUMMARY OF THE INVENTION

In accordance with the present invention, an enamel composition capable of adhering to smooth substrate surfaces and a process of applying the enamel composition to smooth substrates, such as glass or plastic, is described. The enamel composition includes a granular material mixed with a binder having adhesive properties. Moreover, the granular material included in the enamel composition is comprised of minerals, such as, mineral oxides. These minerals, besides enabling the enamel composition to adhere to smooth substrate surfaces, also act as a coloring agent for the enamel composition. This invention eliminates the prior art requirement of heating, curing, chemically treating or roughening the surface of the smooth substrate.

In a further aspect of the present invention, a method including the steps of applying the enamel composition and allowing the enamel composition to dry without heating or special preparation of the substrate, is disclosed.

The foregoing and other features and advantages of the present invention will be apparent from the following more detailed description of the invention.

### DETAILED DESCRIPTION OF THE INVENTION

While this invention is susceptible of embodiments in many different forms, there is herein described in detail, a preferred embodiment of the invention with the understanding that the present disclosure is to be considered as an exemplification of the principles of the invention and is not intended to limit the broad aspects of the invention to the embodiments illustrated herein.

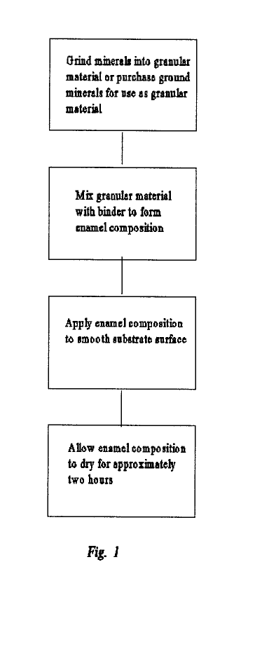

In the preferred embodiment and as exemplified in FIG. 1, an enamel composition 10 for each desired color is produced which is comprised of granular material and a binder with adhesive properties. The enamel composition 10 is applied directly to smooth substrate surfaces 20, such as, glass, without roughening, heating or chemically treating the surface. The granular material is comprised of one or more minerals which are ground to varying degrees of fineness, as is known in the art and depending on the artistic effect desired by the manufacturer. In fact, such ground minerals may be purchased commercially from Beijing Cloisonne Co. The granular material may be caused to vary in color depending on the combination of minerals used to form the granular material. In some cases, dye may also be added to the granular material to achieve a desired color. For example, Table 1 shows the percentage of minerals and/or dye used to form the colors blue and yellow.

TABLE 1
CHEMICAL COMPOSITION OF
BLUE AND YELLOW GRANULAR MATERIAL

| MINERAL | BLUE | YELLOW |
|---|---|---|
| SiO₂ | 46.5% | 37.5% |
| B₂O₃ | 12.6% | 13.75% |
| PbO | 4.6% | 5.1% |
| NaO | 8.7% | — |
| K₂O | 6.5% | — |
| BaO | 11.6% | 7.9% |
| CaO | 8.1% | — |
| CoO | 1.4% | — |
| Na₂O | — | 8.3% |
| ZnO | — | 5.6% |
| Yellow Coloring | — | 14.25% |

As shown in Table 1, a granular material of the color blue is comprised of 46.5% of SiO₂, 12.6% of B₂O₃, 4.6% of PbO, 8.7% of NaO, 6.5% of K₂O, 11.6% of BaO, 8.1% of CaO and 1.4% of CoO. Additionally, the color yellow is comprised of 37.5% of SiO₂, 13.75% of B₂O₃, 5.1% of PbO, 7.9% of BaO, 8.3% of Na₂O, 5.6% of ZnO, and 14.25% of yellow coloring. The mineral combinations shown above can be varied, or additional minerals may be added, to produce an infinite array of colors for the granular material.

The binder, whose commercial name is “106” is a transparent gelatinous composition which has adhesive properties and is commonly used for binding paper. The binder's chemical composition is as follows:

TABLE 2
CHEMICAL COMPOSITION OF BINDER

| COMPOUND | PERCENTAGE |
|---|---|
| HCHO | 37% |
| HCL | 5% |
| NaOH | 5% |
| H₂O | 50% |

The enamel composition 10 is generally comprised of 60% or more granular material and 40% or less binder. Also, the percentages of the granular material and binder can be varied, respectively, to produce different consistency in the enamel composition 10. The granular material and the binder are mixed at room temperatures to form the enamel composition 10.

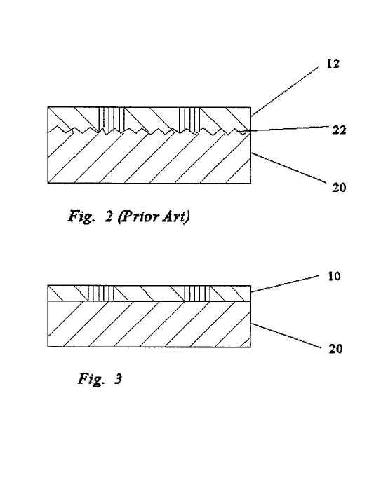

As shown in FIGS. 2 and 3 and as previously mentioned, the enamel composition described above is applied to a smooth substrate surface 20 according to techniques which are generally known in the art, however, the enamel composition 10 is applied without roughening, heating or chemically treating the substrate surface 20. The enamel composition 10 may be applied by a brush or any suitable equivalent. Thus, the enamel composition 10 could be used to create designs on smooth substrate surfaces 20, such as, on the inside of hollow, glass holiday ornaments. Such designs would be formed by the enamel composition 10 whereby colors used to form the design would be produced by providing granular material comprised of a variety of differently colored minerals, as described above. In the preferred embodiment of the invention, the enamel composition 10 should be allowed to dry for approximately 2 hours.

Based on the foregoing description, it will be apparent that a glass manufacturer, such as, for example, a glass ornament manufacturer, may use an artist to apply an enamel composition 10 of this invention to the surface of glass ornaments to form designs without preparing the surface in any way.

Another advantage of the invention, as discussed above, is that glass ornament manufacturers do not need to purchase and maintain additional equipment necessary to fire painted glass ornaments or chemicals to etch the surface or to specially prepare the glass surface of such ornaments in order to properly apply paint to the surface of such ornaments.

While the invention has been particularly shown and described with reference to a particular embodiment thereof, it will be understood by those skilled in the art that various changes in form and detail may be made therein without departing from the spirit and scope of the invention. The present example and embodiment, therefore, are to be considered in all respects as illustrative and not restrictive, and the invention is not to be limited to the details given herein.

We claim:

1. A method of decorating a smooth substrate surface including the steps of:
providing an enamel composition which includes a binder, having an adhesive property, mixed with granular material; and
applying the enamel composition to the substrate surface.

2. The method according to claim 1 wherein the granular material is comprised of minerals.

3. The method according to claim 2 wherein the minerals act as the coloring agent for the enamel composition.

4. The method according to claim 1 wherein the enamel composition is opaque.

5. The method according to claim 1 wherein no heating or special preparation of the substrate is required to enable the enamel composition to adhere to the substrate surface.

6. The method according to claim 1 wherein the substrate is comprised of glass.

7. The method according to claim 1 wherein the substrate is comprised of plastic.

8. An enamel composition capable of being applied to smooth substrate surfaces comprising:
granular material; and
a binder having adhesive properties.

9. The enamel composition according to claim 8 wherein the granular material is comprised of minerals.

10. The enamel composition according to claim 9 wherein the minerals act as the coloring agent for the enamel composition.

11. The enamel composition according to claim 8 wherein the enamel composition is opaque.

12. The enamel composition according to claim 8 wherein no heating or special preparation of the substrate is required to enable the enamel composition to adhere to the substrate surface.

13. The method according to claim 8 wherein the substrate is comprised of glass.

14. The method according to claim 8 wherein the substrate is comprised of plastic.

15. An enamel composition capable of being applied to smooth substrate surfaces wherein no heating or special preparation of the substrate is required for the enamel composition to adhere to the substrate surface comprising:
granular material comprised of minerals where said minerals act as a coloring agent for the enamel composition and where said minerals assist the enamel composition in adhering to the smooth substrate surface; and
a binder having adhesive properties.

16. The enamel composition according to claim 15 wherein the enamel composition is opaque.

17. The method according to claim 15 wherein the substrate is comprised of glass.

18. The method according to claim 15 wherein the substrate is comprised of plastic.

19. A method of decorating a smooth substrate surface, wherein no heating or special preparation of the substrate is required to decorate the smooth substrate surface, including the steps of:
providing a binder having an adhesive property;
providing a granular material;
mixing the binder with the granular material to form an enamel composition; and
applying the enamel composition to the substrate surface.
